(19) United States
(12) Patent Application Publication
(10) Pub. No.: US 2005/0167452 A1
(43) Pub. Date: Aug. 4, 2005

(54) Perfume sample device

(76) Inventor: Jean-Louis Bougamont, Eu (FR)

Correspondence Address: St Onge Steward Johnston & Reens, 986 Bedford Street, Stamford, CT, 06905, US

(21) Appl. No.: 10/503,526

(22) PCT Filed: Jan. 20, 2003
(86) PCT No.: PCT/FR03/00163

(30) Foreign Application Priority Data
Feb. 6, 2002 (FR) 02/01432

(51) Int. Cl. G01F 11/06; G01F 11/30; G01F 11/36; G01F 11/42; B65D 88/54

(52) U.S. Cl. 222/321.9

(57) ABSTRACT

Then invention concerns a liquid product dispenser comprising a reservoir (1) provided with a neck (10), a pump, whereof the body (2) sealingly force-fitted in said neck, encloses a piston (3) co-operating with a return spring (4) with an intake valve and an exhaust valve and bearing an external stem (31) defining an exhaust conduit (30) and a dispensing head (7) mounted on said stem (31) of the piston (3) and bearing an ejection orifice (70). The invention is characterized in that said stem (31) of the piston (3) is extended, in its upper part, by a core (33) complimentarily defining with the inner wall of the dispending head (7) an output channel (37) fed by the exhaust conduit (30) and a spray nozzle (38) wherein emerges said channel (37).

### BACKGROUND OF THE INVENTION

The present invention relates to a liquid product dispenser and more particularly to a perfume sample dispenser.

The known miniature dispensers until now generally include a pump whereof the body, tightly force-fitted in the neck, encloses a piston cooperating with a return spring with an intake valve and an exhaust valve.

The piston bears an external stem defining an internal exhaust conduit and a dispensing head mounted on the stem of the piston and bearing an ejection orifice.

However, these dispensers must have as low a cost as possible because they are only intended for promotion of the product and thus only contain very low volumes.

Moreover, they are intended to be thrown away very quickly after use.

The object of the present invention is to simplify the structure of these dispensers as well as their manufacturing and assembly methods by reducing the number of component parts while improving the efficiency and quality of their operation.

### BRIEF SUMMARY OF THE INVENTION

This object is achieved, according to the invention, by means of a dispenser of the above type, characterized in that the stem of the piston is extended, in its upper part, by a core, complementarily defining with the inner wall of the dispensing head, on the one hand, an output channel fed by the exhaust conduit and, on the other hand, a spray vortex system, wherein emerges the channel.

According to an advantageous feature, the head has a side skirt provided in its lower part with a separable peripheral band ensuring it is locked in the low position by gripping of an inner projection in a retention element arranged on the outer wall of the reservoir.

According to an alternative embodiment, the neck of the reservoir presents a peripheral collar under which the inner projection of the separable band is able to grip.

According to another alternative, the wall of the reservoir comprises a peripheral recess in which the inner projection of the separable band is able to grip.

According to another feature, the intake and exhaust valves are respectively made up of a barrel and a needle borne by a single ram, mobile in the axial direction inside the pump housing and around which the return spring is assembled.

Preferably, the needle is formed by the truncated upper end of the ram, which is intended, during the intake phase, to make close contact with an angular edge of the lower end of the exhaust conduit defining a circular contact zone.

In addition, the barrel is formed by a cylindrical lower portion of the ram, which is intended to sealingly slide in a bore of the body and at a height of which at least one groove is arranged to allow the flow of the product during the intake phase.

Preferably, the diameter of the circular contact zone of the edge with the pointer is less than the inner diameter of the bore of the body.

Moreover, the ram comprises a shoulder for retention of the return spring.

According to yet another feature, the piston comprises a peripheral snap ring intended to abut towards the top against an annular lip borne by the upper edge of the pump housing, while the pump housing has an annular upper flange coming to lie against the neck of the reservoir.

The inventive dispenser comprises a restricted number of parts made of plastic including the reservoir, whereof the manufacture and assembly by moulding are simple, rapid and economic.

In particular, the assembly of the head on the core is easily carried out without preliminary indexing and guarantees nevertheless reliable operation of the spray nozzle.

In addition, the separable band ensures, before use, that the head is maintained in the low position, which guarantees not only the sealing of the pump but also the tamper resistance and satisfactory conservation of the product.

### BRIEF DESCRIPTION OF THE DRAWINGS

The invention will be better understood after reading the following description, with reference to the drawings, wherein:

FIG. 1 is a cross-sectional view of one embodiment of the inventive dispenser before its first use.

FIG. 2 is a cross-sectional view of the dispenser in FIG. 1 after removal of the separable band.

FIG. 3 is a cross-sectional view of the dispenser in FIG. 1 during the dispensing phase of the product.

### DETAILED DESCRIPTION OF ILLUSTRATIVE EMBODIMENTS

The dispenser shown in the figures comprises a reservoir 1 provided with a neck 10, in which a liquid product, such as a perfume, is contained.

A pre-compression pump with a cylindrical tapered body 2 is assembled on the reservoir 1.

For this purpose, the body 2 is force-fitted by tight radial crimping into the neck 10 in the manner of a stopper.

The body 2 has an annular upper flange 21, which comes to lie against the edge of the neck 10, thus limiting the depression of the body 2 in the reservoir 1 and adjusting the position of the plunger tube 22 (partially shown) relative to the liquid level.

The body 2 contains a cylindrical piston 3 cooperating by means of a return spring 4 with an intake valve and an exhaust valve and defining with the wall of the body a dosing chamber.

The piston 3 includes an external stem 31 internally defining an exhaust conduit 30 extending the dosing chamber towards the top.

The stem 31 is surmounted by a dispensing head 7 forming a push-button, which bears an ejection orifice 70.

The stem 31 is extended, in its upper part, by a core 33 complementarily defining with the inner wall of head 7, on the one hand, an output channel 37 fed by the exhaust conduit 30 and, on the other hand, a spray vortex system 38 in which emerges the channel 37. The channel 37 here extends as far as the upper circumference of core 33.

Preferably, the stem 31 and the core 33 form a single and integral part.

This spray vortex system 38, which communicates with the outside via orifice 70, is made up by placing a network of grooves in the front face of core 33 opposite a sealing face on the inner wall of head 7 around orifice 70.

The abutting towards the top of core 33 inside head 7 automatically ensures the tight connection of the conduit, channels and nozzle without it being necessary to envisage indexing of the parts opposite one another.

For whatever purpose it may serve, it is nevertheless possible to envisage on the head or core, a guidance groove cooperating with an axial recess to ensure automatic positioning.

The head 7 has a side skirt 71 provided, in its lower part, with a peripheral band 6 ensuring its guidance is locked in the low position. The band 6 is separable from the head by being attached to the skirt 71 by a zone of weakness 61 capable of being broken or detached by pulling an end tab 63.

Band 6 has a continuous or discontinuous inner projection 62, which is held in the outer wall of the reservoir 1 by attachment in a retention element.

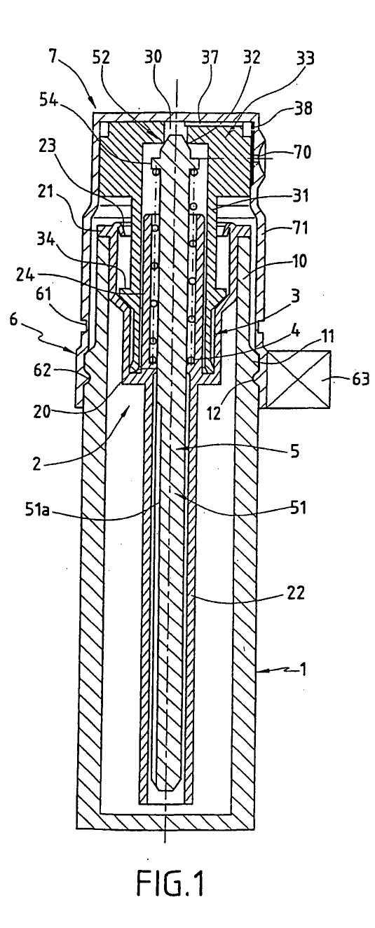

According to a first alternative, the retention element is formed by a collar 11 of the neck of reservoir 1 defined on the drawings by a reduction in thickness of the wall of reservoir 1 or according to another alternative (FIGS. 1 to 3) this element is arranged on the body of the reservoir in the form of a recess 12.

The intake and exhaust valves are respectively formed by a barrel 51 and a needle 52 borne by a single ram 5, which is mobile in the axial direction inside the pump housing 2, and around which the spring 4 is assembled. The body 2 is provided with a coaxial inner sleeve 24 defining, on the one hand, with the side wall of the body a cylindrical zone, in which piston 3 is guided and, on the other hand, with the ram 5 a central housing for the spring 4. The needle 52 is formed by the truncated upper end of the ram 5, which is intended, during the intake phase, to make close contact with an angular edge 32 of the lower end of the exhaust conduit 30.

The barrel 51 is formed, in its turn, by a cylindrical lower portion arranged on the ram 5, which is able to sealingly slide in a bore 20 of the body 2 of the pump.

A groove 51a, however, is implemented at a height of the cylindrical portion to allow, during the intake phase, the flow of the product by suction from the reservoir 1.

Another embodiment, not shown, would consist in providing at this same height of the cylindrical portion a diametrical restriction allowing the flow of the product.

The ram 5 also comprises a shoulder 54 for retention of the spring 4.

The height of ram 5 is such that it occupies, in the low position of the piston, almost the entire inner volume of the plunger tube 22 by allowing only slight play to remain, as shown in FIG. 1, where the head is maintained in the low position against the force of the return spring 4. This arrangement permits fast start-up of the pump since the capacity of the plunger tube is reduced, whereas its own dimensions (height and diameter) remain normal.

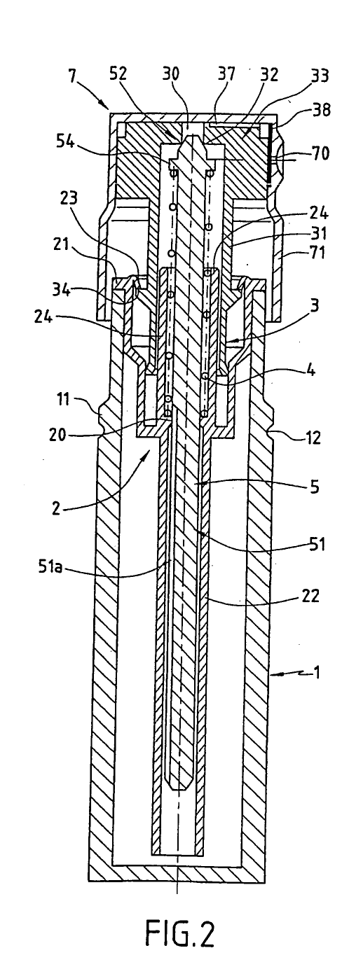

After removal of band 6, as shown in FIG. 2, the head 7 immediately rises under the effect of the spring 4 and the upward stroke of piston 3 sucks the product from reservoir 1 via the tube 22.

In this rest position, the sealing of the device with respect to the exhaust valve is ensured by light contact of the needle 52 against the core 33.

The piston 3 comprises a peripheral snap ring 34 intended to abut towards the top against an annular lip 23 borne by the upper edge of the body 2 of the pump.

The lip 23 is a deformable lip, which can be unfolded outwardly in order to allow the body to be ejected from the mould during production and which is subsequently folded back inwardly.

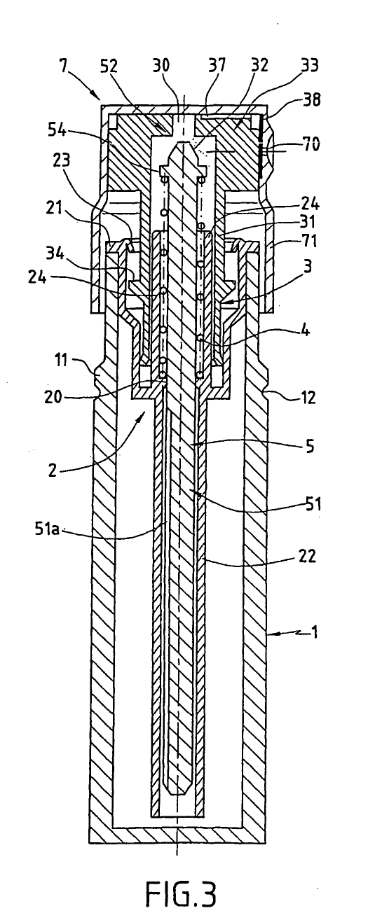

During the compression phase shown in FIG. 3, the pressure increases in the dosing chamber until the exhaust valve succumbs and lets the product flow towards the conduit 30.

The set point of the exhaust valve is adjusted by suitable choice of material and dimension of the contact zone between the needle 52 and the lower edge 32 of the conduit 30, so that it can open once the intake valve is closed.

Preferably, the contact zone between the needle 52 and the edge 32 is circular and its diameter is less than the inner diameter of the bore 20 of the body 2.

### SEQUENCE LISTING/COMPUTER PROGRAM LISTING

(only if a paper listing less than 11 pages)

1. Dispenser of liquid type products comprising:
a reservoir a provided with a neck;
a pump, whereof the body is sealingly force-fitted in said neck, enclosing a piston co-operating by means of a return spring with an intake valve and an exhaust valve and bearing an external stem defining an exhaust conduit; and
a dispensing head mounted on said stem of the piston and bearing an ejection orifice
wherein said stem of the piston is extended, in its upper part, by a core, complementarily defining with the inner wall of the dispensing head, on the one hand, an output channel fed by the exhaust conduit and, on the other hand, a spray vortex system in which emerges said channel.

2. Dispenser according to claim 1, wherein said head has a side skirt provided in its lower part with a separable peripheral band ensuring it is locked in the low position by attachment of an inner projection in a retention element arranged on the outer wall of the reservoir.

3. Dispenser according to claim 2, wherein the neck of said reservoir presents a peripheral collar, under which the inner projection of the separable band is able to grip.

4. Dispenser according to claim 2, wherein the wall of the reservoir comprises a peripheral recess, in which the inner projection of the separable band is able to grip.

5. Dispenser according to claim 1 wherein said intake and exhaust valves are made up, respectively, of a barrel and a needle borne by a single ram mobile in the axial direction inside the body of the pump and around which the return spring is assembled.

6. Dispenser according to claim 5, wherein said needle is formed by the truncated upper end of the ram which is intended, during the intake phase, to make close contact with an angular edge of the lower end of the exhaust conduit defining a circular contact zone.

7. Dispenser according to claim 5, wherein said barrel is made up of a cylindrical lower portion of the ram, which is intended to sealingly slide in a bore of said body and at a height of which at least one groove is arranged allowing the flow of the product during the intake phase.

8. Dispenser according to claims 6, wherein the diameter of the circular contact zone of the edge with the needle is less than the inner diameter of the bore of the body.

9. Dispenser according to claim 5 wherein said ram comprises a shoulder for retention of return spring.

10. Dispenser according to claim 1 wherein said piston comprises a peripheral snap ring intended to abut towards the top against an annular lip formed by the upper edge of the body of the pump.

11. Dispenser according to claim 1 wherein said body of the pump has an annular upper flange coming to lie against the neck of the reservoir.

12. A dispenser for a liquid type product comprising:
a reservoir having a neck;
a pump comprising a body sealingly fitted to said neck and a piston comprising a stem defining an exhaust conduit; and
a dispensing head mounted on said stem of said piston, the dispensing head comprising an ejection orifice,
wherein the stem of the piston forms a core at its upper part, the core and the inner surface of the dispensing head defining an output channel fed by the exhaust conduit and a spray vortex system fed by the channel.

13. The dispenser according to claim 12, wherein the dispensing head comprises a side skirt in its lower part with a separable peripheral band for locking the dispensing head in a low position.

14. The dispenser according to claim 12, wherein the neck of the reservoir presents a peripheral collar, under which the inner projection of the separable band is able to grip.

15. The dispenser according to claim 12, further comprising a ram, the ram being movable in an axial direction inside the body of the pump and forming an intake and exhaust valve in combination with the body and the piston respectively.

16. The dispenser according to claim 15, wherein a needle is formed by the truncated upper end of the ram, the exhaust valve being formed by the needle and an angular edge of a lower end of the exhaust conduit.

17. The dispenser according to claim 15, wherein a barrel is formed by a cylindrical lower portion of the ram, the barrel for sealingly sliding in a bore of the body, the intake valve being formed by a groove in the barrel arranged to allow flow of the product from the reservoir during an intake phase.

18. Dispenser according to claim 17, wherein the angular edge of the lower end of the exhaust conduit defines a circular contact zone with the needle having a diameter less than an inner diameter of the bore of the body.

19. The dispenser according to claim 15, wherein the ram comprises a shoulder for retention of a return spring.

20. The dispenser according to claim 12, wherein the piston comprises a peripheral snap ring abutting an annular lip formed by an upper edge of the body of the pump.
